(19) United States
(12) Patent Application Publication
(10) Pub. No.: US 2014/0185758 A1
(43) Pub. Date: Jul. 3, 2014

(54) APPARATUS AND METHOD FOR INCREASING ENERGY DIFFERENCE IN MULTI-ENERGY X-RAY (MEX) IMAGES

(71) Applicant: Samsung Electronics Co., Ltd., Suwon-si (KR)

(72) Inventors: Dong Goo KANG, Hwaseong-si (KR); Myung Jin CHUNG, Seoul (KR); Sung Su KIM, Yongin-si (KR); Young Hun SUNG, Hwaseong-si (KR); Hying Hwa OH, Hwaseong-si (KR)

(73) Assignee: SAMSUNG ELECTRONICS CO., LTD., Suwon-si (KR)

(21) Appl. No.: 14/018,500

(22) Filed: Sep. 5, 2013

(30) Foreign Application Priority Data
Dec. 27, 2012 (KR) 10-2012-0154341

(51) Int. Cl. G01N 23/04

(52) U.S. Cl. CPC G01N 23/04
USPC 378/62

(57) ABSTRACT

An apparatus for acquiring a MEX image includes an X-ray source to generate and irradiate a multi-peak X-ray spectrum onto an object, and an energy identifying detector to obtain a MEX generated when the irradiated multi-peak X-ray spectrum passes through an object.

### CROSS-REFERENCE TO RELATED APPLICATION

This application claims priority from Korean Patent Application No. 10-2012-0154341, filed on Dec. 27, 2012, in the Korean Intellectual Property Office, the entire disclosure of which is incorporated herein by reference.

### BACKGROUND

1. Field

Methods and apparatuses consistent with exemplary embodiments relate to a multi-energy X-ray (MEX) imaging, and, more particularly, to increasing an energy difference in MEX images to be used in mammography, general radiography, computerized tomography (CT), and the like.

2. Description of the Related Art

X-rays are widely used in various fields to acquire medical information of the patients.

The X-rays are generated when electrons generated by a cathode filament strike an anode target. When the generated X-rays are irradiated to an object, the X-rays may be attenuated based on a material or a characteristic of the object, and X-rays passing through the object may form an image on a detector installed behind the object.

### SUMMARY

Exemplary embodiments may address at least the above problems and/or disadvantages and other disadvantages not described above. Also, exemplary embodiments are not required to overcome the disadvantages described above, and an exemplary embodiment may not overcome any of the problems described above.

According to an aspect of an exemplary embodiment, there is provided an apparatus for acquiring a MEX image, the apparatus including an X-ray source to generate and irradiate a multi-peak X-ray spectrum, an energy identifying detector to obtain a MEX generated when the irradiated multi-peak X-ray spectrum passes through an object to be imaged, and a MEX image processor to process the acquired MEX to generate an image.

According to an aspect of an exemplary embodiment, there is provided a method of acquiring a MEX image, the method including generating and irradiating a multi-peak X-ray spectrum, by an X-ray source, obtaining a MEX generated when the irradiated multi-peak X-ray spectrum passes through an object to be imaged, by an energy identifying detector, and processing the acquired MEX to generate an image, by a MEX image processor.

### BRIEF DESCRIPTION OF THE DRAWINGS

The above and/or other aspects will become more apparent by describing certain exemplary embodiments, with reference to the accompanying drawings, in which:

FIG. 1 is a graph illustrating a single-peak X-ray spectrum according to a related art;

FIG. 2 is a block diagram illustrating an apparatus for acquiring a MEX image according to an exemplary embodiment;

FIG. 3 is a graph illustrating a dual-peak X-ray spectrum according to an exemplary embodiment;

FIG. 4 is a graph illustrating a triple-peak X-ray spectrum according to an exemplary embodiment;

FIG. 5 is a graph illustrating a photon counting detector (PCD) sensitivity function when a single-peak X-ray enters an object to be imaged according to an exemplary embodiment;

FIG. 6 is a graph illustrating a PCD sensitivity function when a dual-peak X-ray enters an object to be imaged according to an exemplary embodiment;

FIG. 7 is a graph illustrating spectra of a filter array detector when a single-peak X-ray enters an object to be imaged according to an exemplary embodiment;

FIG. 8 is a graph illustrating spectra of a filter array detector when a dual-peak X-ray enters an object to be imaged according to an exemplary embodiment; and

FIG. 9 is a flowchart illustrating a method of acquiring a MEX image according to an exemplary embodiment.

### DETAILED DESCRIPTION

Certain exemplary embodiments are described in greater detail below with reference to the accompanying drawings.

In the following description, the same drawing reference numerals are used for the same elements even in different drawings. The matters defined in the description, such as detailed construction and elements, are provided to assist in a comprehensive understanding of exemplary embodiments. Thus, it is apparent that exemplary embodiments can be carried out without those specifically defined matters. Also, well-known functions or constructions are not described in detail since they would obscure exemplary embodiments with unnecessary detail.

When it is determined that a detailed description is related to a related known function or configuration which may make the purpose of the present disclosure unnecessarily ambiguous in the description, such detailed description will be omitted. Also, terminologies used herein are defined to appropriately describe the exemplary embodiments and thus may be changed depending on a user, the intent of an operator, or a custom. Accordingly, the terminologies should be defined based on the following overall description of this specification.

A large number of X-ray systems may display images using an attenuation characteristic detected when X-rays having a single energy band pass through an object. In such X-ray systems, when materials constituting the object have different attenuation characteristics, a good quality image may be acquired. However, when the materials have similar attenuation characteristics, an image quality may be deteriorated.

A system using a MEX may acquire an X-ray image of at least two energy bands. In general, a material may have different X-ray attenuation characteristics in different energy bands. Accordingly, such characteristics may be used for decomposing an image for each material.

In particular, the MEX imaging is a technology in which a contrast between materials is increased by using a difference in absorption characteristics of human body materials changing based on energy. Related art MEX technologies may be classified into a multiple exposure technique, and a single exposure technique.

In a multiple exposure technique, a MEX image may be acquired by exposing X-rays having different X-ray spectra, sequentially. For example, by changing an anode target of a source, a material/thickness of a filter, a tube voltage of an X-ray tube, and the like, a shape of an X-ray spectrum, a position of centroid energy, or the like may be changed.

As a difference in energies of an acquired image increases, a contrast of an X-ray image may be increased through a MEX image analysis, for example, an energy subtraction. Accordingly, in order to acquire a high quality X-ray image, proper selection of a type of an anode target, a material of a filter, a tube voltage, and the like may be needed to minimize a change in energy and an overlap phenomenon.

In contrast to the multiple exposure technique, a MEX image may be acquired at a single exposure, in the single exposure technique.

For example, an X-ray source may generate a single wide spectrum, for example, a tungsten (W) target of 50 kilovolt peaks (kVp), and a detector may identify energy levels of an incident X-ray photon, whereby images for each energy level may be acquired simultaneously.

The detector capable of identifying energies may include a PCD, a dual layer detector, a filter array detector, and the like.

The single exposure technique may differ from the multiple exposure technique in that a plurality of MEX images may be acquired simultaneously and, thus, the single exposure technique may reduce an image acquisition time and occurrence of a motion artifact resulting from a time difference of the multiple exposure technique.

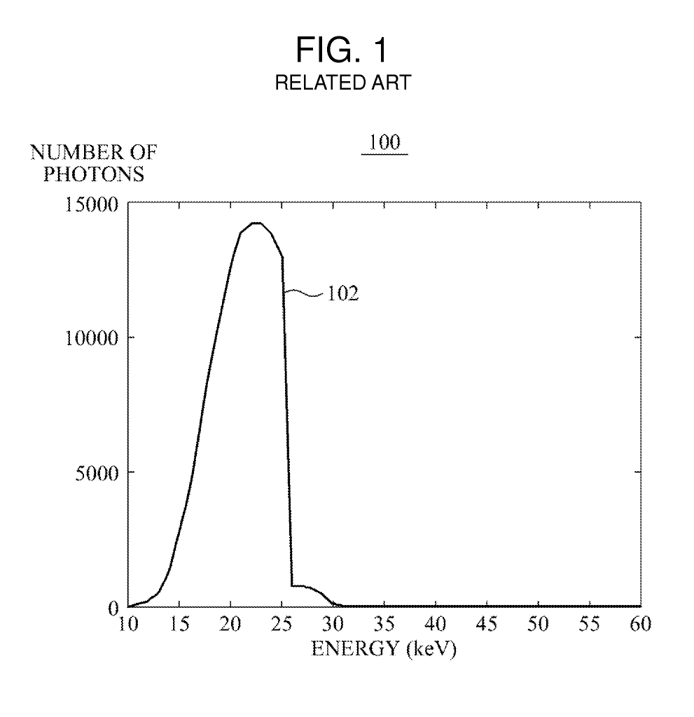

FIG. 1 is a graph 100 illustrating a single-peak X-ray spectrum 102 according to a related art.

The single-peak X-ray spectrum may be obtained by properly selecting a type of an anode target of a tube, and a type and thickness of an external filter. Here, the external filter may include, for example, at least one of a molybdenum-molybdenum (Mo/Mo) filter, a molybdenum-rhodium (Mo/Rh) filter, a rhodium-rhodium (Rh/Rh) filter, a tungsten-aluminum (W/Al) filter, a tungsten-rhodium (W/Rh) filter, and a tungsten-silver (W/Ag) filter. An X-ray quality of the single-peak X-ray spectrum may increase as the single-peak X-ray spectrum becomes closer to a monochromatic X-ray having a single energy or a single wavelength.

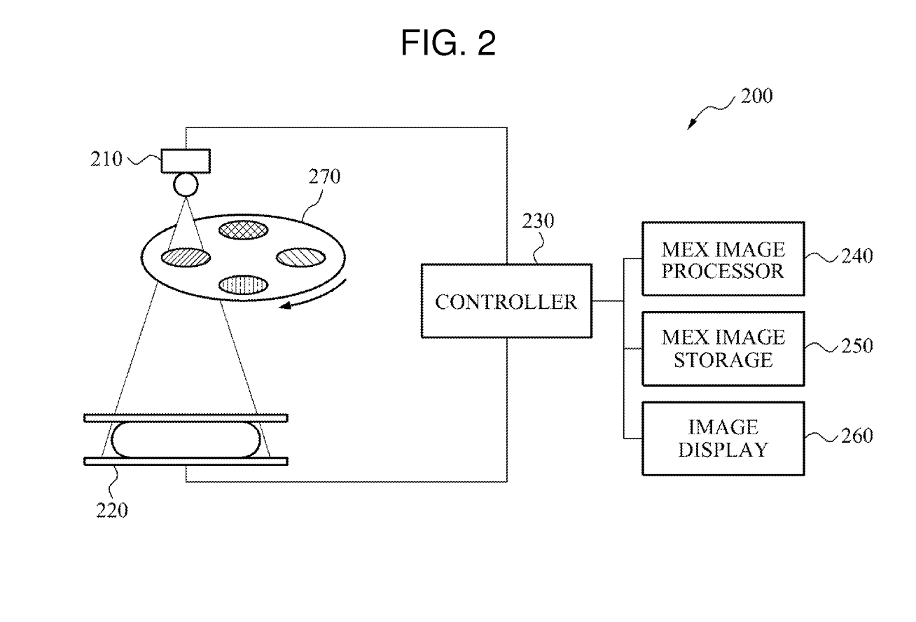

FIG. 2 is a block diagram illustrating an apparatus 200 for acquiring a MEX image according to an exemplary embodiment.

Referring to FIG. 2, the apparatus 200 may include an X-ray source 210, an energy identifying detector 220, a controller 230, a MEX image processor 240, a MEX image storage 250, and an image display 260.

The X-ray source 210 may generate a multi-peak X-ray spectrum, and irradiate the multi-peak X-ray spectrum to an object to be imaged, for example, a patient.

The energy identifying detector 220 may obtain a MEX generated when the irradiated multi-peak X-ray spectrum passes through the object to be imaged.

According to the present exemplary embodiment, the X-ray source 210 may simultaneously irradiate the generated multi-peak X-ray spectrum to the object to be imaged. The X-ray source 210 may increase the effect of the single exposure technique described above. In particular, the multi-peak X-ray spectrum may be generated by the X-ray source 210 and energy separation may be performed by the energy identifying detector 220.

For example, the X-ray source 210 may generate a dual-peak X-ray spectrum, using a high tube voltage corresponding to a few kilovolt peaks (kVp) and a K-edge filter. For example, tin (Sn), Ag, Rh, and the like may be used for the K-edge filter.

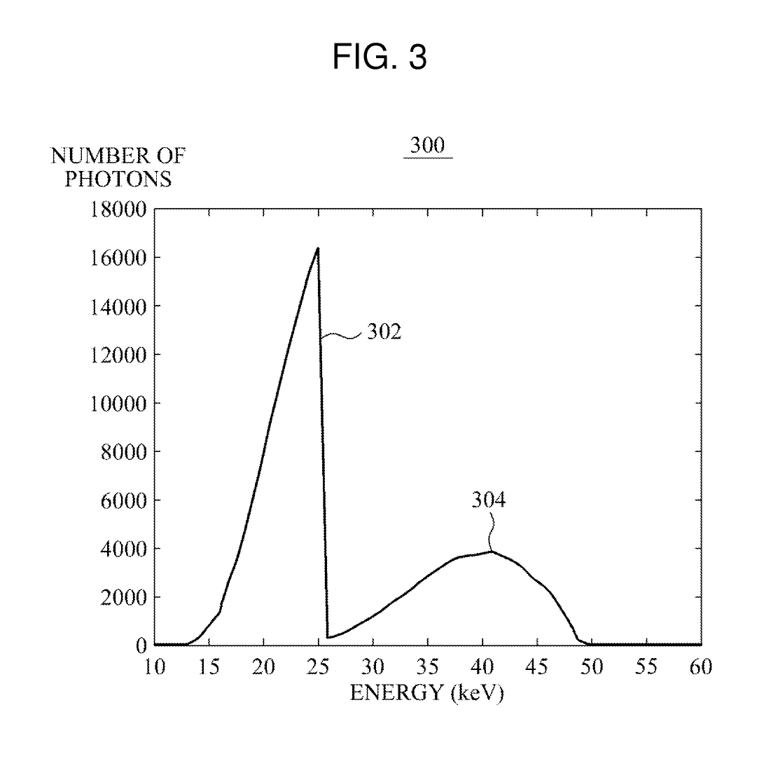

FIG. 3 is a graph 300 illustrating a dual-peak X-ray spectrum having two peaks 302 and 304 generated using a high tube voltage corresponding to a few kVp and a K-edge filter according to an exemplary embodiment.

A material having a proper K-edge may be used for the K-edge filter depending on a location of an object energy defined by multi-energy.

The X-ray source 210 may generate the multi-peak X-ray spectrum using multiple K-edge filters. In particular, the X-ray source 210 may generate a multi-peak X-ray spectrum having at least three peaks, using at least two overlapping K-edge filters, each having a K-edge disposed at different positions.

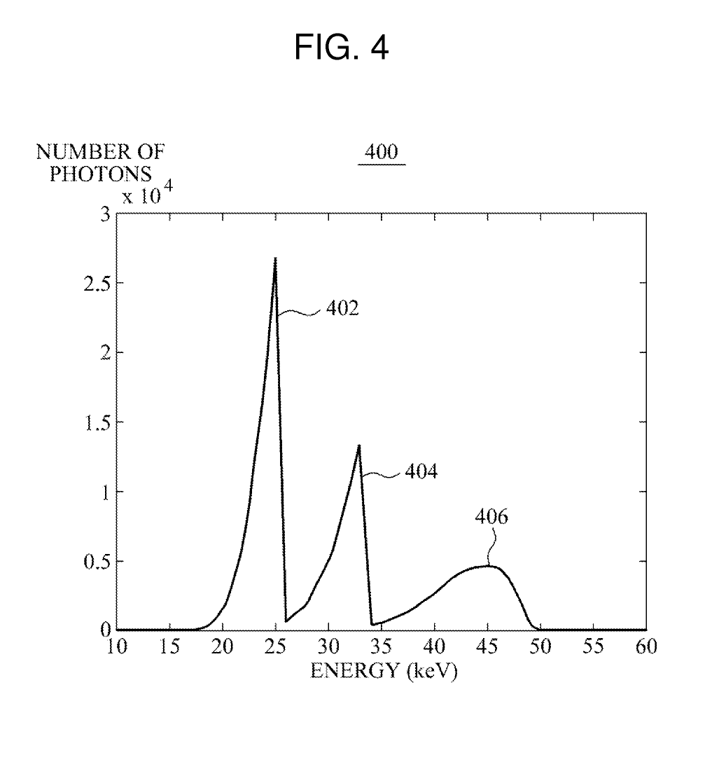

FIG. 4 is a graph 400 illustrating a triple-peak X-ray spectrum having at least three peaks 402, 404, and 406 generated using at least two overlapping K-edge filters, each having a K-edge disposed at a different position according to an exemplary embodiment.

The X-ray source 210 may employ a technique of selectively transmitting a predetermined wavelength using a monochromatic X-ray filter.

In particular, the X-ray source 210 may generate a plurality of monochromatic X-rays using the monochromatic X-ray filter selectively transmitting a predetermined wavelength, in lieu of a filter using an attenuation characteristic of an X-ray. For example, the X-ray source 210 may generate the plurality of monochromatic X-rays using a Bragg filter.

Different regions of the object or objects may be disposed on an anode track so that the X-rays may be transmitted through the different regions of the object. A multi-peak X-ray spectrum may be generated in which respective spectra corresponding to the different regions of the object are combined, while rotating the anode track.

The apparatus 200 may set respective filters 270 corresponding to the different regions of the object or objects to be fixed in a direction in which X-rays are transmitted, and generate a multi-peak X-ray spectrum in which spectra corresponding to respective target-filter combinations are combined, while rotating the filters simultaneously.

The energy identifying detector 220 may be a PCD.

The PCD may be a detector capable of identifying an energy of the MEX entering an object to be imaged, by mapping a density of energy to at least one of an amount of current and a level of voltage, and thresholding the mapped information electrically.

The energy identifying detector 220 may predetermine an energy range of the MEX entering the object to be imaged, and a thickness and a material of the object to be imaged before a position of the thresholding is imaged. In addition, the energy identifying detector 220 may determine the position of the thresholding for an energy bin defined by an energy threshold to include a peak position of the multi-peak X-ray spectrum.

The energy identifying detector 220 may include a filter array detector and may determine a MEX spectrum, by selecting a material and a thickness of a filter disposed between an X-ray sensor of a filter array detector and an object to be imaged.

For example, the energy identifying detector 220 may use a filter capable of performing relatively great attenuation on at least two peaks among a portion of peaks or multiple peaks of the multi-peak X-ray spectrum, when compared to the other peaks.

The MEX image processor 240 may process the acquired MEX to generate an image.

The MEX image storage 250 may store the processed MEX in a storage medium.

The image display 260 may display the processed MEX.

The controller 230 may control at least one of the X-ray source 210, the energy identifying detector 220, the MEX image processor 240, the MEX image storage 250, and the image display 260 as an image.

The apparatus 200 may reduce an energy overlap effect caused by a non-ideal spectral response of a PCD, using an energy separation effect of a multi-peak X-ray spectrum.

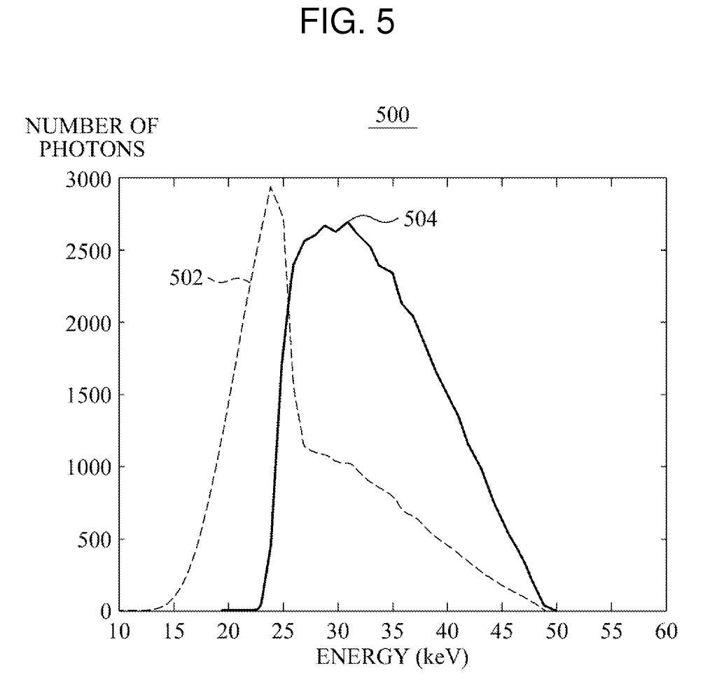

Such an effect may be understood using graphs 500 through 800 of FIGS. 5 through 8.

In the graphs 500 through 800, dotted lines indicate a low energy sensitivity function, and solid lines indicate a high energy sensitivity function.

Here, a sensitivity function may refer to a final energy spectrum determined by an energy response function of a detector and an energy spectrum of a source.

In detail, FIG. 5 is the graph 500 illustrating a PCD sensitivity function when a single-peak X-ray enters an object to be imaged according to an exemplary embodiment. The graph 500 may have a characteristic of 49 kVp, and W/Al 2 mm. Here, 49 kVp indicates a tube voltage of an X-ray tube, W indicates a type of anode target, Al indicates a type of external filter, and 2 mm indicates a thickness of an external filter. An energy threshold corresponding to bin1 may be 20-25 keV (corresponding to the area under the peak 502) and to bin2 may be 25-50 keV (corresponding to the area under the peak 504).

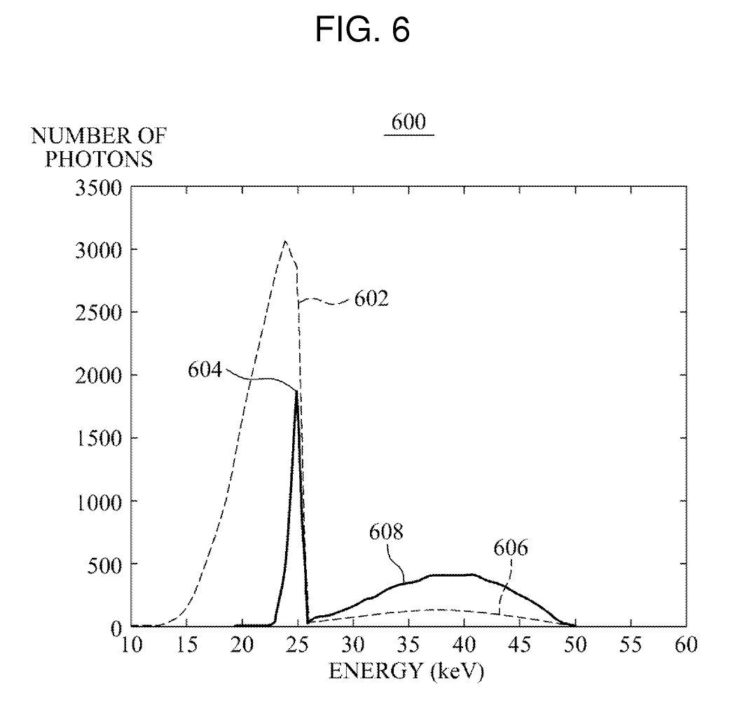

FIG. 6 is the graph 600 illustrating a PCD sensitivity function when a dual-peak X-ray enters an object to be imaged according to an exemplary embodiment. The graph 600 may have a characteristic of 49 kVp, and W/Ag 0.09 mm. Here, 49 kVp indicates a tube voltage of an X-ray tube, W indicates a type of anode target, Ag indicates a type of external filter, and 0.9 mm indicates a thickness of an external filter. An energy threshold corresponding to bin1 may be 20-25 keV (corresponding to the areas under the peaks 602 and 604) and to bin2 may be 25-50 keV (corresponding to the areas under the graphs 606 and 608).

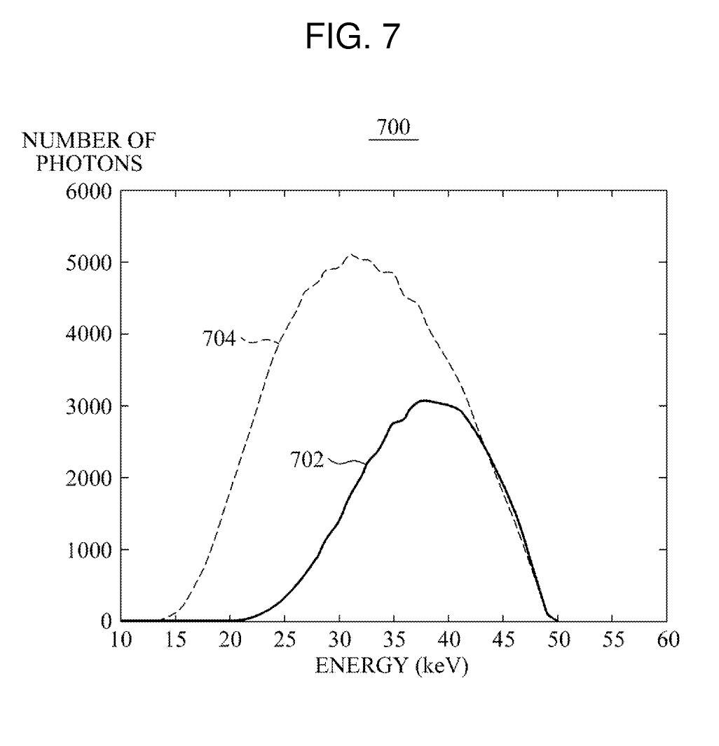

FIG. 7 is the graph 700 illustrating spectra of a filter array detector when a single-peak X-ray enters an object to be imaged according to an exemplary embodiment. The graph 700 may have a characteristic of 49 kVp, and a W/Al 2 mm source spectrum. In the graph 700, a solid line 702 indicates a case when a filter is not used, and a dotted line 704 indicates that a filter, for example, a copper (Cu) filter having a thickness of 0.2 mm is used.

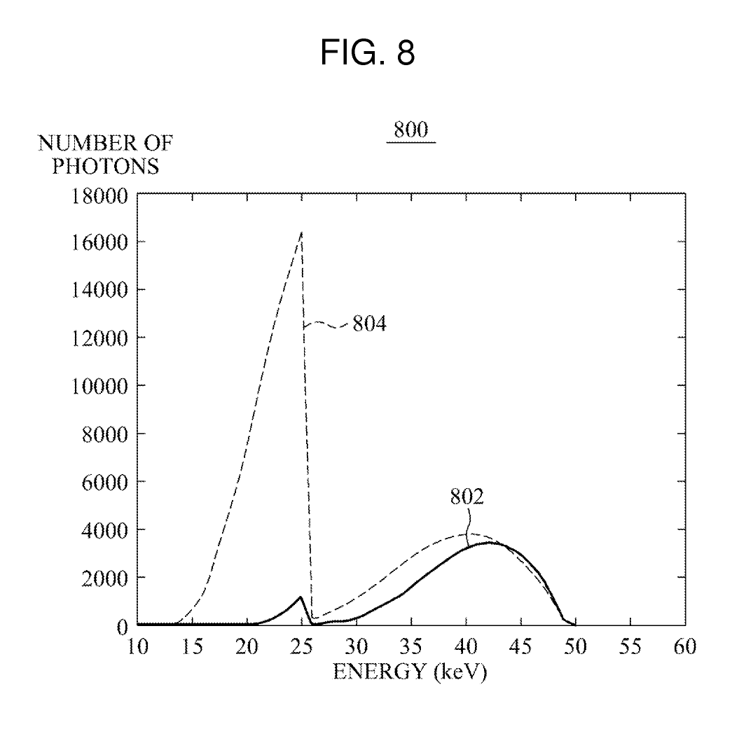

FIG. 8 is the graph 800 illustrating spectra of a filter array detector when a dual-peak X-ray enters an object to be imaged according to an exemplary embodiment. The graph 800 may have a characteristic of 49 kVp, and a W/Ag 0.09 mm source spectrum. In the graph 800, a solid line 802 indicates a case when a filter is not used, and a dotted line 804 indicates a case when a filter, for example, a Cu filter having a thickness of 0.2 mm is used.

A thickness of a filter used for the filter array detector may be reduced by the energy separation effect of the multi-peak X-ray spectrum. Accordingly, a grid effect occurring when a relatively thick filter is used may be reduced.

In addition, an X-ray loss between an object to be imaged and an X-ray sensor may be reduced, whereby a radiation dose to which a patient is exposed, and image noise may be reduced.

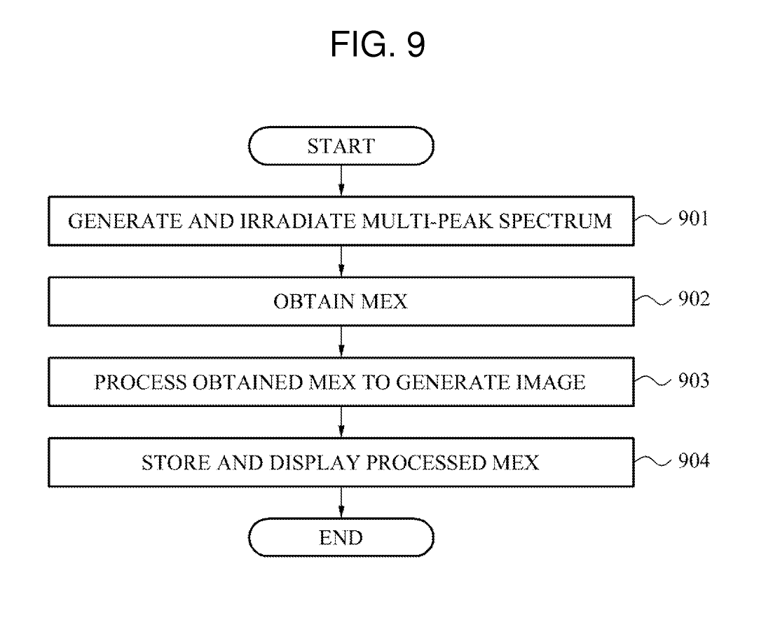

FIG. 9 is a flowchart illustrating a method of acquiring a MEX image according to an exemplary embodiment.

In the method of FIG. 9, a technique of increasing an energy difference by combining an X-ray source generating a multi-peak X-ray spectrum and an energy identifying detector capable of acquiring a MEX image is described.

The method may increase an energy separation performance in order to take an advantage of a single exposure technique and alleviate disadvantages of the single exposure technique. Accordingly, the method may reduce an energy difference and overlap, thereby increasing a contrast between materials, reducing an artifact and noise of an image, and reducing a radiation dose to which a patient is exposed.

In particular, in operation 901, a multi-peak X-ray spectrum may be generated and irradiated by the X-ray source.

The multi-peak X-ray spectrum may be generated using a high tube voltage corresponding to a few kVp and a K-edge filter.

In addition, a multi-peak X-ray spectrum having at least three peaks may be generated using at least two overlapping K-edge filters disposed at different positions.

In operation 902, a MEX generated when the irradiated multi-peak X-ray spectrum passes through an object to be imaged may be obtained by the energy identifying detector.

In order to obtain the MEX, a density of energy may be mapped to at least one of an amount of current and a level of voltage, and the mapped information may be thresholded electrically to identify an energy of the MEX entering the object to be imaged.

In operation 903, the obtained MEX may be processed by a MEX image processor to generate an image.

In operation 904, the processed MEX may be stored and displayed.

The method for acquiring a MEX image according to the above-described exemplary embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations of the above-described exemplary embodiments, or vice versa.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An apparatus for acquiring a multi-energy X-ray (MEX) image, the apparatus comprising:
an X-ray source which generates and irradiates a multi-peak X-ray spectrum onto an object; and
an energy identifying detector configured to obtain a MEX generated when the irradiated multi-peak X-ray spectrum passes through the object.

2. The apparatus of claim 1, further comprising:
a MEX image processor configured to process the acquired MEX and generate an image.

3. The apparatus of claim 1, wherein the X-ray source generates the multi-peak X-ray spectrum by using a high tube voltage corresponding to a few kilovolt peaks (kVp) and a K-edge filter.

4. The apparatus of claim 1, wherein the X-ray source generates a multi-peak X-ray spectrum having at least three peaks by using at least two overlapping K-edge filters disposed at different positions.

5. The apparatus of claim 1, wherein the X-ray source generates monochromatic X-rays by selectively transmitting a predetermined wavelength using a monochromatic X-ray filter.

6. The apparatus of claim 1, wherein the energy identifying detector is configured to map a density of energy to at least one of a current amount and a voltage level, and to threshold the mapped information electrically to identify an energy of the MEX passed through the object.

7. The apparatus of claim 6, wherein the energy identifying detector is configured to predetermine an energy range of the MEX passing through the object, and a thickness and a material of the object before a position of the thresholding is imaged.

8. The apparatus of claim 7, wherein the energy identifying detector is configured to determine the position of the thresholding for an energy bin defined by the thresholding to include a peak position of the multi-peak X-ray spectrum.

9. The apparatus of claim 2, further comprising:
a MEX image storage which stores the processed MEX.

10. The apparatus of claim 2, further comprising:
an image display which displays the processed MEX as an image.

11. A method of acquiring a multi-energy X-ray (MEX) image, the method comprising:
generating a multi-peak X-ray spectrum;
irradiating the multi-peak X-ray spectrum toward an object; and
obtaining a MEX after the irradiated multi-peak X-ray spectrum passes through the object.

12. The method of claim 11, further comprising:
processing the acquired MEX to generate an image.

13. The method of claim 11, wherein the generating comprises generating the multi-peak X-ray spectrum by using a high tube voltage corresponding to a few kilovolt peaks (kVp) and a K-edge filter.

14. The method of claim 11, wherein the generating comprises generating the multi-peak X-ray spectrum having at least three peaks by using at least two overlapping K-edge filters disposed at different positions.

15. The method of claim 11, wherein the obtaining comprises:
mapping a density of energy to at least one of a current amount and a voltage level; and
thresholding the mapped information electrically to identify an energy of the MEX passing through the object.

16. A non-transitory computer-readable medium comprising a program which when executed by a computer causes the computer to perform the method of claim 11.
